(19) United States
(12) Patent Application Publication
(10) Pub. No.: US 2011/0208561 A1
(43) Pub. Date: Aug. 25, 2011

(54) GLOBAL RECEIPT CARD SYSTEM AND METHOD

(76) Inventor: Shelly Shante Randall, Flower Mound, TX (US)

(21) Appl. No.: 13/031,623

(22) Filed: Feb. 22, 2011

Related U.S. Application Data
(60) Provisional application No. 61/307,300, filed on Feb. 23, 2010.

(51) Int. Cl. G06Q 10/00

(52) U.S. Cl. 705/7.32; 705/1.1

(57) ABSTRACT

A system and method for collecting global purchase details using a consumer identifier are provided. During a business transaction, the details of the transaction are associated with the consumer identifier. The consumer identifier, located on an affinity card or a mobile device, allows for the collection of information on an external storage device from business transactions from a plurality of different, related and/or unrelated merchants. The consumer can subsequently access and download the information from the transaction onto a personal computer. Through a merchant identifier, the data/information may also be accessed and re-read by the merchant for future related transactions. Consequently, the transaction process may provide the consumer an affinity relationship with multiple, related or unrelated merchants through a single unique consumer identifier that eliminates the necessity of paper receipts with those merchants.

### CLAIM OF PRIORITY UNDER 35 U.S.C. §119

The present application for patent claims priority to U.S. Provisional Application No. 61/307,300 entitled “GLOBAL RECEIPT CARD SYSTEM AND METHOD”, filed Feb. 23, 2010 and is hereby expressly incorporated by reference herein.

### FIELD

One feature relates a global receipt card system and method for collecting and storing global purchase details from business transactions with a plurality of different merchants.

### BACKGROUND

When a consumer purchases an item from a merchant, the sale is typically electronically recorded through a cash register or computerized system and the consumer is provided with a paper receipt of the recordation of the sale. The paper receipt typically identifies the name and location of the merchant, the date and time of the purchase, scan/code number associated with the item, the price of the item (including any discount applied, sales tax and total sale price) and the type of payment used (credit card, cash, check). An electronic record of the sale is also kept by the merchant. If the consumer wants to return the purchased item or make subsequent sale adjustments, the merchant that sold the purchased item requires access to the paper receipt. That is, the consumer must have the paper receipt in order to return the item.

Consummation of the purchase/sale can take many forms including the use of an affinity card that is specifically associated with a single merchant. The consumer provides the merchant with the card or alternatively, a consumer provides a phone number which is associated with the card when completing the purchase allowing the merchant to track what consumers are purchasing. Using data accumulated from the affinity cards, merchants can better serve their consumers by stocking popular items and providing specific discounts tailored to the needs and wants of specific consumers.

Although current affinity cards allow merchants to collect useful data and provide consumers with benefits, each affinity card is restricted to use with a specific merchant allowing merchants to track data only associated with their particular stores. Furthermore, current affinity cards do not allow consumers to track their purchases from a plurality of different, unrelated merchants and maintain an electronic receipt of all purchases. Therefore, what is needed is a global receipt card system and method that is useable at a plurality of different, unrelated merchants and allows consumers to collect and store global purchase details of transactions.

### SUMMARY

One feature is directed to a method for collecting global purchase details. The method includes a consumer identifier being associated with a consumer allowing the consumer to collect transaction information on purchases made with a plurality of different merchants. When transacting business with a merchant, the consumer provides the consumer identifier to the merchant. The consumer identifier may be a barcode that is located on an affinity card or may be displayed on a display of a mobile device. The merchant may use a card reader to obtain or scan the barcode from the affinity card or the mobile device during the business transaction between the consumer and the merchant. Alternatively, the merchant may manually enter the consumer identifier into a merchant device.

Upon completing the business transaction, the merchant device may send the transaction information, along with the consumer identifier, to an external storage device where the transaction information is associated with the consumer identifier. The consumer identifier may be used as an address in the external storage device for storing all transaction information from all merchants in which the consumer conducts business.

The merchant may have a merchant identifier allowing the merchant to associate and collect data from business transactions with a plurality of consumers. The data collected may be used for marketing and may be provided in the form of summary reports. To generate the summary reports, the merchant may provide search criteria for organizing the transaction information. The criteria can include the consumer, place of purchase, date of purchase, price, payment method and types of purchases.

Using the merchant identifier and the consumer identifier, the merchant can look up the transaction history between the merchant and the consumer or a particular transaction between the merchant and the consumer. The transaction history can be used by the consumer to return a purchased item thus eliminating the need to have a paper receipt.

Another feature provides a merchant device for collecting global purchase details. The merchant device includes a network interface for communicating over a wireless network; a processing circuit coupled to the network interface and adapted to (i) obtain a consumer identifier from a consumer during a business transaction between the consumer and a merchant, the consumer identifier used for collecting consumer business transaction data from consumer purchases from a plurality of merchants; (ii) complete the business transaction between the consumer and the merchant; and (iii) transmit consumer business transaction data from the business transaction to an external storage device where the consumer business transaction data is associated with the consumer identifier on the external storage device. The merchant device may also include a card reader coupled to the network interface and the processing circuit for reading the consumer identifier from an affinity card or the display of a mobile device.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 is a block diagram illustrating the internal functional architecture of a computer system.

FIG. 2 is a block diagram illustrating a general overview of a dynamic global receipt card system according to one aspect of the present invention.

FIG. 3 is a flow diagram illustrating the operation of a wireless communication system in which a global receipt card may be used to collect information from business transactions from a plurality of different merchants.

FIG. 4 is a block diagram illustrating an example of a merchant device configured to collect and record transactions with a consumer.

FIG. 5 illustrates a method for collecting transaction information from business transactions between a consumer and a plurality of different merchants.

FIG. 6 illustrates an example of a screen used by a merchant to search for information by date ranges.

FIG. 7 illustrates an example of a screen showing an itemized list of transactions between a consumer and a merchant.

FIG. 8 illustrates an example of a screen used by a merchant when a consumer returns an item.

FIG. 9 illustrates an example of a login screen from the program used by a consumer to retrieve information from the external storage device.

FIG. 10 illustrates an example of a screen used by a consumer to enter search criteria when searching for information.

FIG. 11 illustrates an example of a screen used by a consumer to show search results in the form of a summary of purchases.

FIG. 12 illustrates an example of a screen used by a consumer to show search results in the form of a summary of purchases which appear when the search criteria selected is the name of the merchant.

FIG. 13 illustrates an example of a screen from the program used by a merchant to enter search criteria when searching for information.

FIG. 14 illustrates an example of a screen from the program used by the merchant to further narrow the search by selecting additional search criteria.

FIG. 15 illustrates an example of a screen used by a merchant to show search results in the form of a summary of purchases.

FIG. 16 illustrates an example of a screen used by a merchant to identifying locations on a map where specific products are located.

### DETAILED DESCRIPTION

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

In the following description, certain terminology is used to describe certain features of one or more embodiments of the invention. The terms “computer system” and “computing device” refer to a desktop device, a mobile device, a wireless device, a mobile phone, a mobile communication device, a user communication device, personal digital assistant, mobile palm-held computer, a laptop computer and/or any general purpose computer system. The term “mobile device” refers to smart phones, mobile phones, pagers, personal digital assistants, and/or personal information managers (PIMs) which communicate, at least partially, through a wireless or cellular network. The term “consumer” refers to any recipient in a business transaction including, but not limited to an individual, groups of individuals, organizations, businesses, Governments, etc. The term “merchant” refers to any entity in a business transaction that is exchanging or selling items of value, such as information, goods and services.

According to one feature, a system and method for collecting global purchase details using a consumer identifier is provided. During a purchase or business transaction, instead of being issued a paper receipt, the details of the purchase may be associated with a consumer identifier which is a unique identifier that allows for the collection of information from business transactions from a plurality of different, related or unrelated merchants. The consumer identifier is used to store, compile and display the information related to the transaction on an external storage device, i.e. database. The consumer may have the ability to subsequently access and download the information from the transaction onto a personal computer to be viewed or organized as desired. Through a merchant identifier, the data/information may also be accessed and re-read by the merchant for future related transactions. Consequently, the transaction process may provide the consumer an affinity relationship with multiple, related or unrelated merchants through a single unique consumer identifier that eliminates the necessity of paper receipts with those merchants. Furthermore, the global data/information from all purchases or transactions may be accumulated for market research and summary resale to merchant subscribers.

According to another feature of the present invention, a universal receipt format for consumer usage, uploadable to an external storage device or a data warehouse and to various computer accounting programs is created.

According to another feature of the present invention, disparate affinity and purchase records may be combined into a single database.

According to yet another feature of the present invention, consumers may be provided with a complete, readily accessible history of all purchases.

According to yet another feature of the present invention, merchants may be provided with easier access to purchase data for future interactions with consumers (warranty, merchandise returns, credit programs, etc.).

According to yet another feature of the present invention, merchants may be provided with easily accessible consumer information (or merchant business transaction data) and complete summary purchase history, regardless of purchase method.

According to yet another feature of the present invention, merchants may be provided with global market information, beyond what can currently be attained through private affinity programs.

According to yet another feature of the present invention, smaller, independent merchants may be permitted to obtain global market information regarding product sales, consumer trends, etc.

According to yet another feature of the present invention, consumers may be permitted to carry a single affinity card for a plurality of related and/or unrelated merchants.

According to yet another feature of the present invention, paper usage and printing of receipts for consumers utilizing the card program may be eliminated.

According to yet another feature of the present invention, the system and method may provide for (1) recording non-purchase financial transactions such as charitable donations, medical and other service provider transactions, utility payments, etc., (2) E-commerce connectivity, (3) Global Receipt Card smart phone connectivity applications; (4) Global Receipt Cards issued individually or to groups (business, family, school, affinity group, etc.) with individual identifiers, permitting collective data for the group, as well as individual information and (5) Optional gift transfer capabilities—consumer may transfer a purchase record to a 3rd-party subscriber, permitting gift receipt recording.

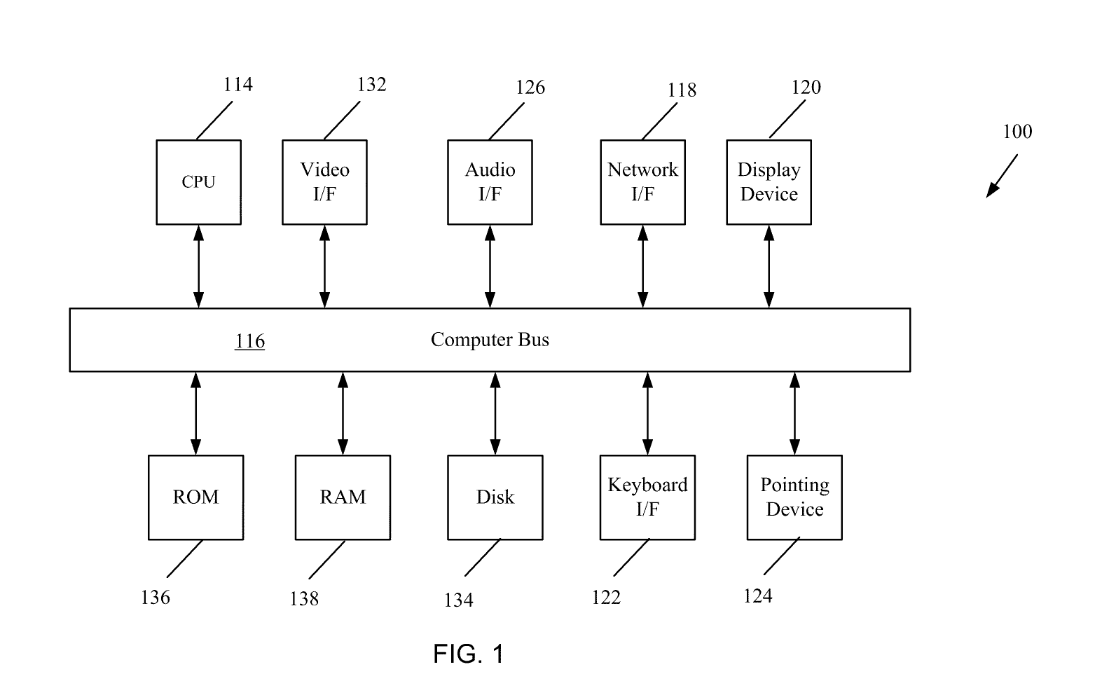

FIG. 1 is a block diagram illustrating the internal functional architecture of a computer system 100 usable with one or more aspects of the systems and methods described in further detail below. As shown in FIG. 1, the computer system 100 may include a central processing unit (CPU) 114 for executing computer-executable process steps and interfaces with a computer bus 116. Also shown in FIG. 1 are a network interface 118, a display device interface 120, a keyboard or input interface 122, a pointing device interface 124, an audio interface 126, a video interface 132, and a hard disk drive 134.

As described above, the disk 134 may store operating system program files, application program files, web browsers, and other files. Some of these files may be stored on the disk 134 using an installation program. For example, the CPU 114 may execute computer-executable process steps of an installation program so that the CPU 114 can properly execute the application program.

A random access main memory (“RAM”) 136 may also interface to the computer bus 116 to provide the CPU 114 with access to memory storage. When executing stored computer-executable process steps from the disk 134, the CPU 114 stores and executes the process steps out of the RAM 136.

Read only memory (“ROM”) 138 may be provided to store invariant instruction sequences such as start-up instruction sequences or basic input/output operating system (BIOS) sequences for operation of the keyboard 122.

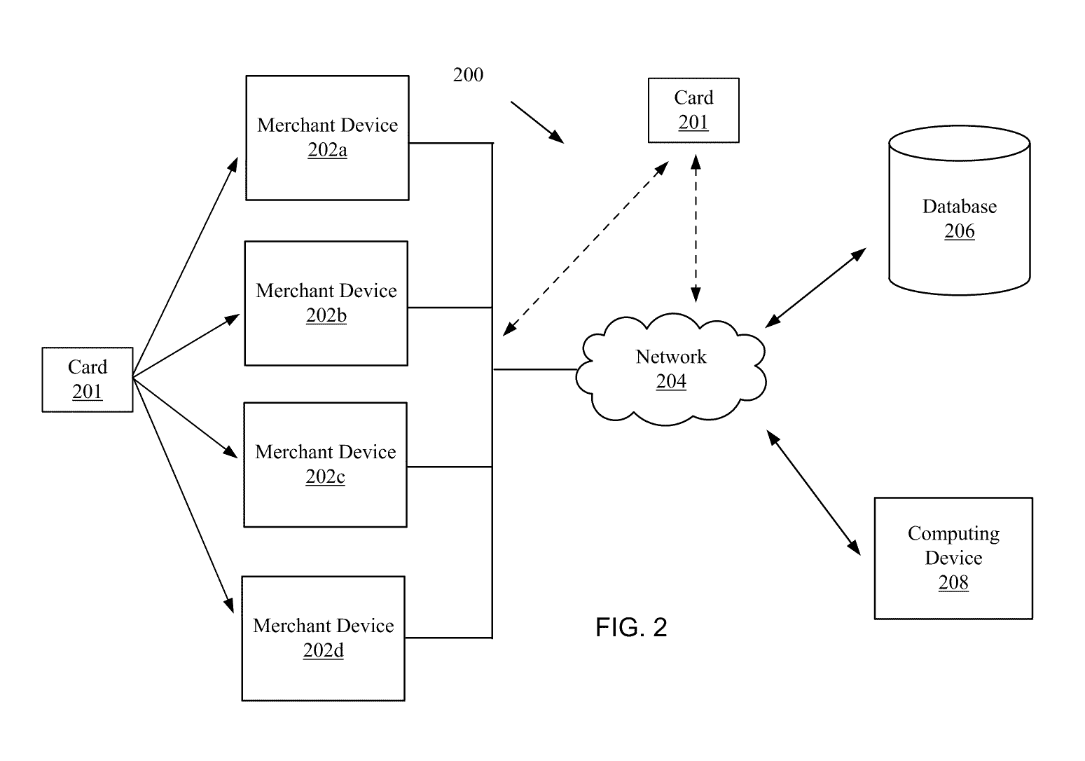

FIG. 2 is a block diagram illustrating a general overview of a dynamic global receipt card system 200 according to one aspect of the present invention. In the dynamic global receipt card system 200, a user or consumer (hereinafter used interchangeably) may utilize a unique identifier (i.e. consumer identifier) associated with a single global receipt card 201 to record and store global transaction details providing the consumer complete access to business transaction records and information. The consumer identifier may be in the form of a barcode and may be displayed on a global receipt (or affinity) card 201. In one aspect, the card 201 may be in the form of a mobile device and the display screen on the mobile device is used to display and present the consumer identifier (or barcode) to a merchant. If the card is in the form of a mobile device, the card 201 may be connected to the network 204. Transactions may include, but are not limited to, an agreement, communication, or movement between separate entities or objects, for the exchange of items of value, such as information, goods, services, and money.

The dynamic global receipt card system 200 may include a plurality of different, related or unrelated, merchants 202a-202d each of which may have a merchant device, described in detail below, for collecting data using unique consumer identifiers associated with global receipt (or affinity) cards of consumers. The merchant device may be included in, or separate from a sales device in which the merchant completes the transaction, such as a cash register. Each of the merchants 202a-202d may be coupled to a network 204, such as the Internet, through which it communicates with one or more external storage devices or databases 206 for recording and storing details of the transaction. In one embodiment, each consumer identifier may be used as an address location in the external storage devices allowing consumers to easily access their particular transaction information/data (i.e. consumer business transaction data). Additionally, each merchant may have a unique merchant identifier allowing the merchant to collect and stored details of transactions with a plurality of different customers. In one embodiment, each merchant identifier may be used as an address location in the external storage devices allowing merchants to easily access merchant business transaction data.

A general purpose computer system or computing device 208, including, but not limited to, a desktop and a mobile device may be utilized by the consumer to connect to the external storage device 206, via the network 204, and access transaction information (i.e. consumer business transaction data) associated with the consumer identifier of the card 201. Consumers and merchants may download the information into programs stored on the general purpose computing device 208. The programs may include, but are not limited to, accounting software (QuickBooks, Quicken, etc.) and common database or spreadsheet software (Access, Excel, etc.) Furthermore, as described in detail below, the consumer may generate reports for information related to an individual transaction, groups of transactions or all transactions based on various search criteria (date range of purchases, price range of purchases, merchant, types of purchases, payment methods, etc.)

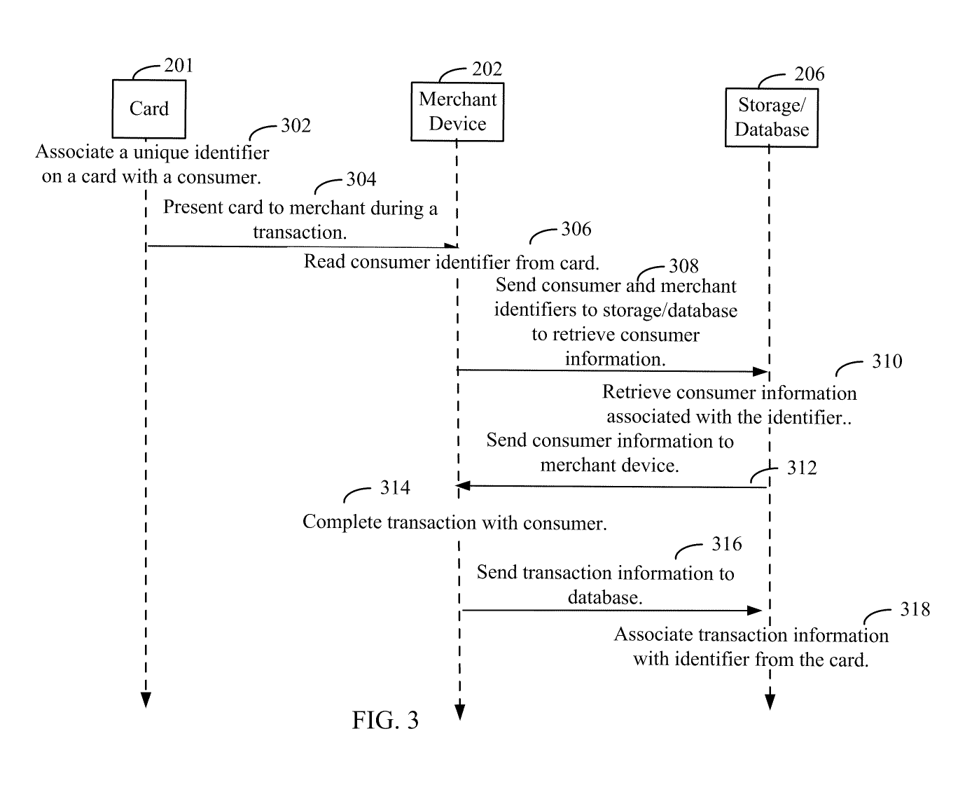

FIG. 3 is a flow diagram illustrating the operation of a wireless communication system in which a consumer identifier associated with a global receipt (or affinity) card may be used to collect information from business transactions from a plurality of different merchants. The merchants may be related, for example franchisees for the same franchisor, or the merchants may be completely unrelated. In this example, the card 201, merchant device 202 and storage/database 206 of FIG. 2 are used for illustration purposes. First, a unique consumer identifier on a card is associated with a consumer 302. When the consumer wishes to make a purchase and record the transaction using the consumer identifier of the card, the consumer presents the consumer identifier (generally in the form of the card or the display screen of a mobile device which is displaying the consumer identifier, typically in the form of a barcode) to a merchant during the transaction 304. Using a scanner or card reader associated with the merchant device, the consumer identifier is read from the card 306. Alternately, the merchant my manually type in the consumer identifier into the merchant device.

The merchant device may send the consumer identifier, along with a merchant identifier, to the database (or external storage device) to retrieve information on transactions between the consumer and the merchant 308. Using the consumer and merchant identifiers, transaction information between the consumer and merchant is retrieved from the database (or external storage device) 310. The transaction information may include the name of the consumer and transaction history between the consumer and the merchant. This information may then be sent to the merchant device 312. The merchant may use this transaction information to provide additional benefits to the consumer. Benefits may include discounts based on the transaction history of the consumer with the merchant. Additionally, as discussed below, the merchant may use this information to assist the consumer with a return or exchange of an item purchased from the merchant. Upon completion of the transaction between the consumer and merchant 314, the transaction information on the current transaction is sent to the database 316 where it is associated with the identifier of the consumer (or stored in a location in the database identified by the consumer identifier and/or merchant identifier) 318. As a result, the consumer may track his/her purchases (i.e. consumer business transaction data) and the merchant may track its sales (i.e. merchant business transaction data).

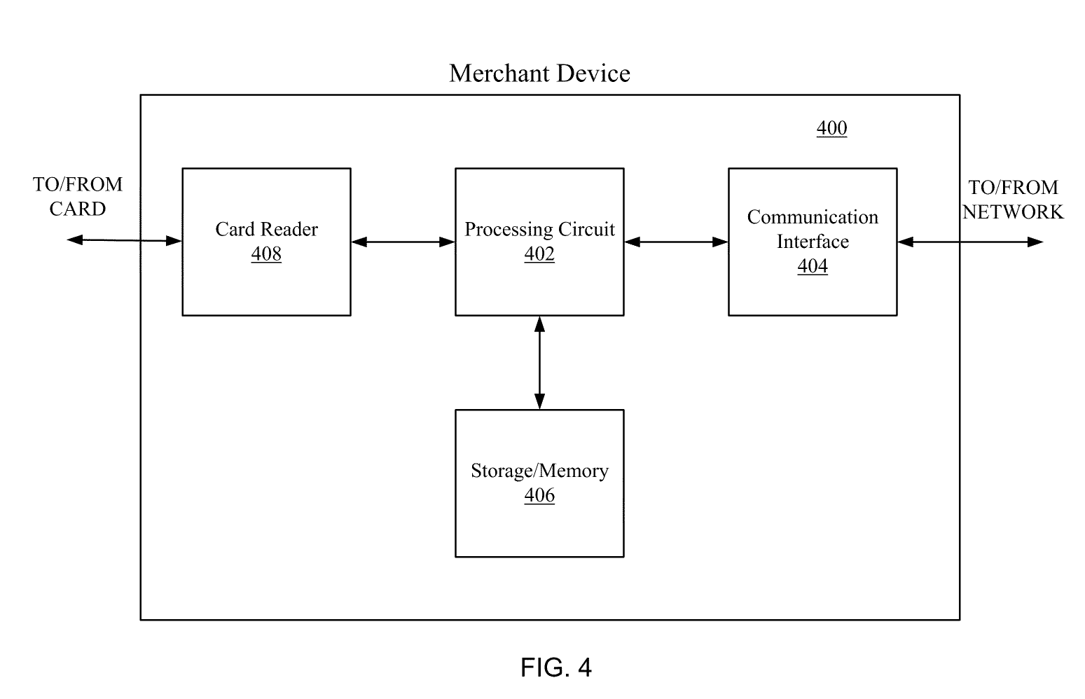

FIG. 4 is a block diagram illustrating an example of a merchant device 400 configured to collect and record transaction data between a consumer and a merchant. The merchant device 400 may include a processing circuit 402 (e.g., processor, processing module, etc.) coupled to a communication interface 404 to communicate with a network, such as the Internet, and a memory device 406 to locally store information. The processing circuit 402 may be coupled to card reader (or scanner) 408 which may be integrated into the merchant device or may be external to the merchant device providing interface and secure data connection to an external storage device.

During or after a transaction, a global receipt card associated with a consumer may be inserted, swiped or scanned by a card reader of the merchant device, depending on the system, so that a consumer identifier or a unique secure consumer identification code (such as a telephone number) may be retrieved from the card. Alternatively, as described above, the consumer identifier may also be displayed on a display of a mobile device or may be entered into the merchant device manually by the merchant.

This consumer identifier, along with the merchant identifier, may be used to allow the merchant to transmit, as well as receive, transaction information or data, to/from the external storage device (i.e. web-based or other secure centralized data warehouse) where it may be record (including reverse transaction record—return merchandise, credit, etc.). The transaction information may include, but is not limited to a cardholder identifier, merchant information (such as name, store ID/location, type/category), date/time of the transaction, purchase details (specific item/service, Universal Product Code (UPC) and store Stock Keeping Unit (SKU) numbers, item category, price, price variance (discounts, units, etc.), tax identifier, tax rate, tax amount and purchase method/type record (cash, check, credit, etc.)

In one embodiment, if the consumer is completing the business transaction via the Internet, e-commerce functionality similar with user ID and password/PIN may be utilized. That is, with regard to online e-merchant sales, direct electronic connectivity to the external storage device may be accomplished through secure ID utilizing consumer ID and password/PIN. The recorded information may be consistent with in-person merchant sale data and coordinated with on-line e-payment systems (PayPal, etc.).

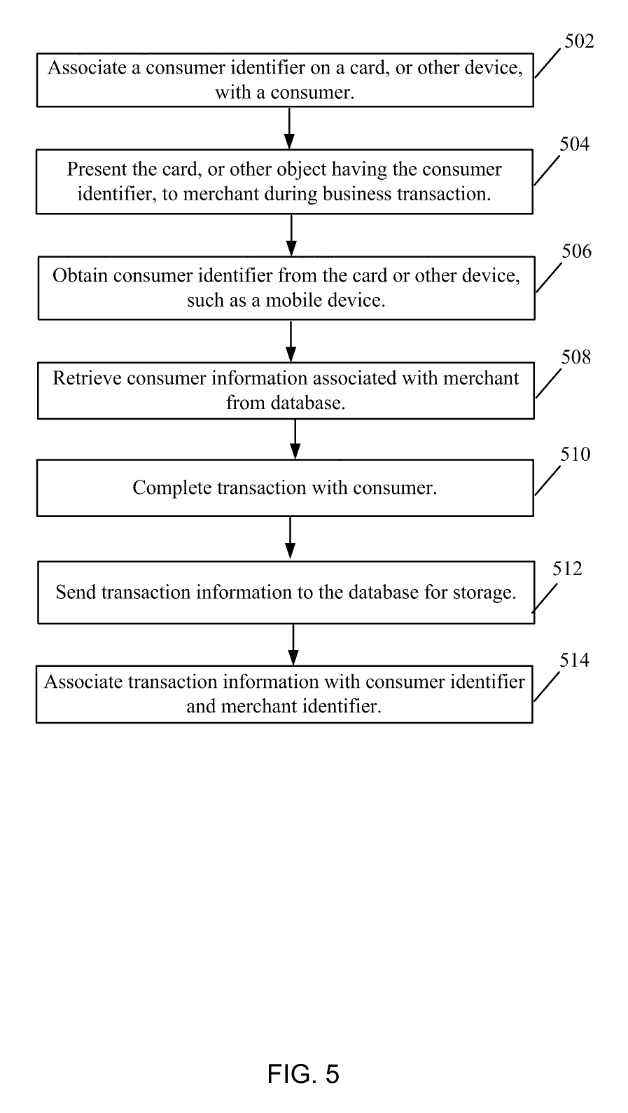

FIG. 5 illustrates a method for collecting transaction information from business transactions between a consumer and a plurality of different, related and/or unrelated, merchants. First, an application to register for an account may be applied for and the consumer may be provided a card, such as an affinity card or other device, associated with (or having) a unique consumer identifier 502. Individuals, groups of individuals, merchants, organizational groups, commercial groups, etc. may apply for a card. When applying for a card, the consumer may be requested to provide personal identifying information, general socio-economic information (marital status, occupation category, income range, etc.). In one embodiment, a consumer may add additional family members to the account. For example, every member of a family may be provided with a card having the same unique consumer identifier. Groups may be asked to provide consumer identifying information, general information (organization or business type, scale, etc.) and subaccount and individual user information. Merchants may be asked to provide merchant identifying information, general merchant type information and merchant transaction detail information including systems and equipment, interface and connectivity protocols and sale record detail and rules. Merchants may be provided with a unique merchant identifier to track purchases of its consumers and keep track of inventory. The card may be a smart card, a magnetic stripe card or any other type of card capable of storing or display a consumer identifier. In one embodiment, the consumer identifier is a barcode and may be display on the card or may be displayed on a display of a mobile device.

Next, upon entering into a business transaction with another, such as a merchant, the consumer may present the card, or other device, such as a mobile device, having the consumer identifier, to the merchant 504 so that the merchant may then obtain the consumer identifier using a merchant device (as described above) either integrated into or electrically connected to a cash register or other device 506. The consumer identifier may be associated with consumer information which may include, but is not limited to, the name of the consumer, age of the consumer and address of the consumer. The consumer may also pre-authorize automatic credit/debit card information, permitting purchases to be completed in a single electronic transaction when using the consumer identifier associated with the card or other device.

The merchant device may then send the customer identifier to the database (or external storage device) to retrieve consumer information associated with the merchant 508. The consumer information may include, but is not limited to, a history of the purchases the consumer has made with the merchant. This consumer information may be used by the merchant to offer the consumer deals or discounts on items as well as allow the consumer to easily return or exchange an item without a paper receipt. Next, the transaction with the consumer may be completed 510 and the transaction information may be sent to the external storage device (or database) for storage over a network 512, as discussed above, and stored on the external storage device for later retrieval, as discussed below. The transaction information may also be associated with the consumer identifier and the merchant identifier 514. The consumer identifier and the merchant identifier may be used as address locations in the external storage device and the transaction information is stored at the respective addresses to associate the transaction information with the consumer and merchant identifiers. The specific transaction information may include information related to the merchant (name, store identifier/location, type/category of store), the date and time of the transaction, details of the purchase (specific item purchased, UPS and SKU numbers), item category, price, price variance (discounts, units, etc.), tax identifier, tax rate, tax amount and the purchase method (credit card, check, cash). The merchant may determine which specific information (i.e. merchant business transaction data) to maintain or the specific information may be pre-determined.

By storing the information in an external storage device, a paper receipt does not have to be provided to the consumer which is environmentally friendly and saves the consumer time by not having to search for paper receipts allowing for easier returns of purchases. Optionally, the transaction information may automatically be transmitted directly to a consumer device or e-mail account from the external storage device (database). Consequently, the business or individual may be notified every time the consumer identifier, or card or card or other device, is used so that unauthorized uses may be easily and quickly identified. It should also be noted that original transaction information may still be maintained in the external storage device (or database) for security and accuracy. In this regard, only a merchant, with the consumer logged on, may make a change to the records (return, exchange, price adjustment, etc.) Neither can change the original transaction information unilaterally.

### Retrieving Information Stored on External Storage Device

To retrieve stored data, the consumer may utilize a dedicated program for the global receipt card downloaded onto a computing device which may provide security controlled access to the external storage device. The program may allow the consumer to display purchase record data (i.e. consumer business transaction data) on the computing device.

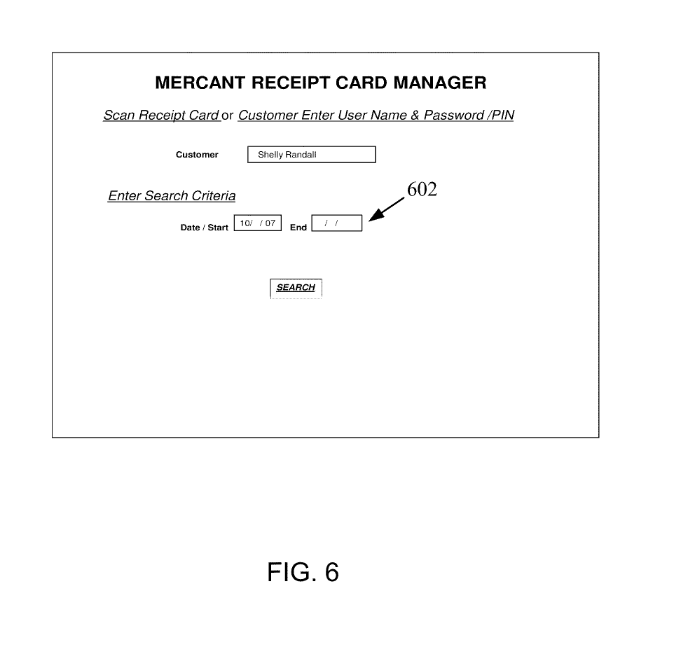

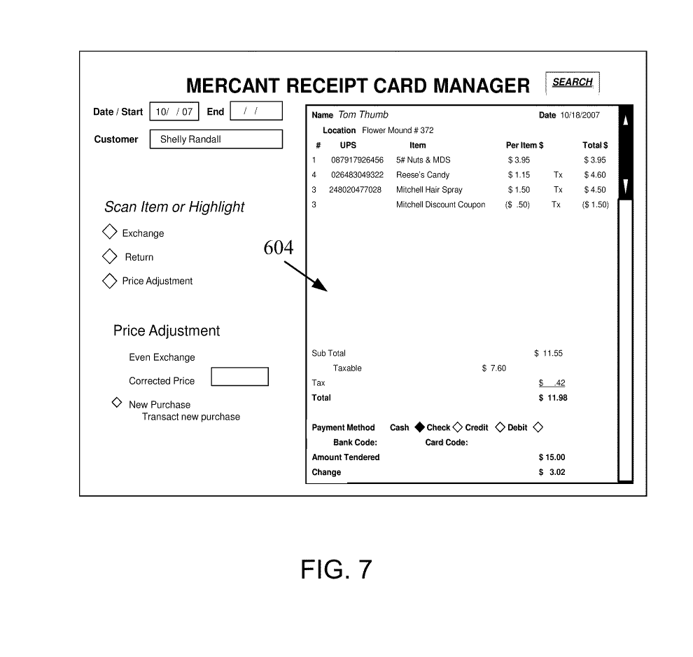

FIGS. 6-8 illustrate screen shots from a program used to retrieve information from the external storage device. As shown in FIG. 6, the merchant may access the external storage device by reading the consumer identifier off the card or other device (i.e. using a card reader attached to the computer device) or by entering a password and PIN number. In one embodiment, the merchant or consumer may search transaction information by a specific date or specific date range 602. Alternatively, the merchant or consumer may utilize other search criteria such as a specific merchant, price, item, method of payment, etc. The information may be compiled and summarized for the merchant in a table 604. (See FIG. 7)

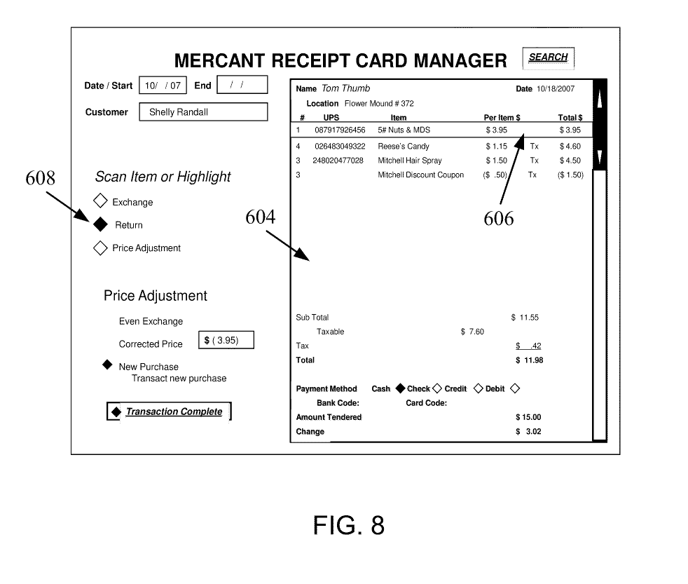

The merchant may utilize the present system and method when a consumer desires to return an item. For example, when a consumer returns a purchased item to the merchant, the merchant may utilize information stored on the external storage device associated with the consumer identifier and the merchant identifier to see details of the transaction with the consumer. The information the merchant can view may be customizable by the merchant. The information may be transmitted from the external storage device to the local register monitor/screen of the merchant or alternatively, a document with the information may be printed through the register/computer. The consumer identifier associated with the global receipt card allows a consumer to return an item without having a paper receipt as the merchant may reverse data for select purchases. As can be seen in FIG. 8, if a consumer is returning an item, the merchant selects or highlights 606 the item to be returned from the list of transactions identified in the table 604 and selects the return button 608.

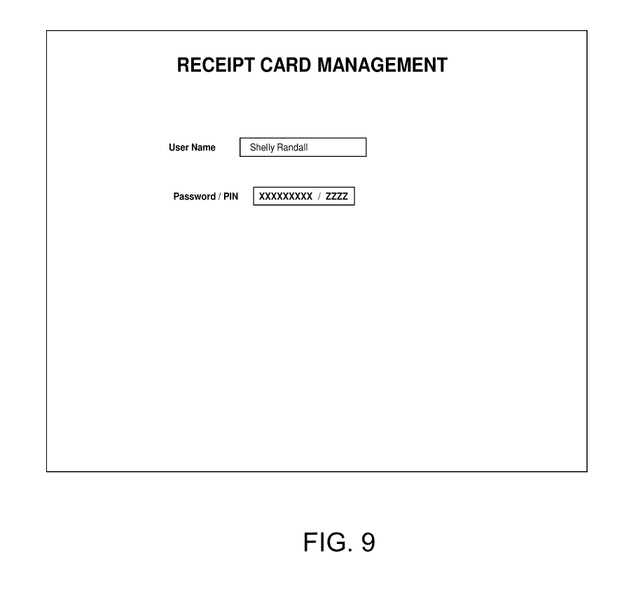

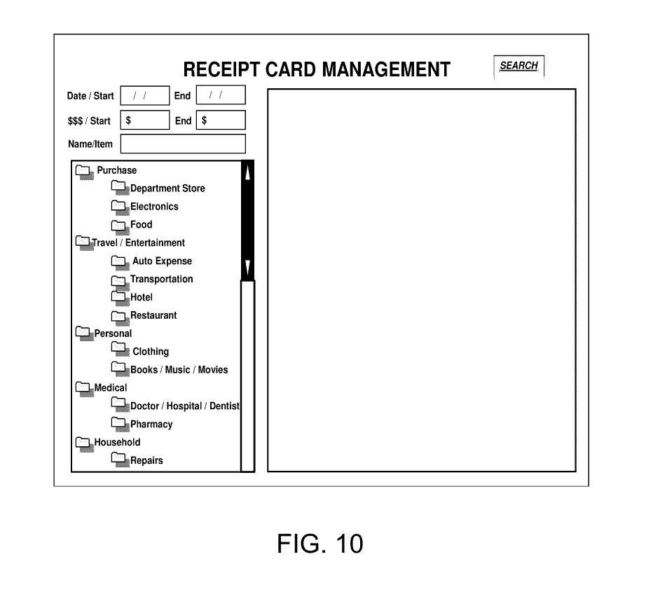

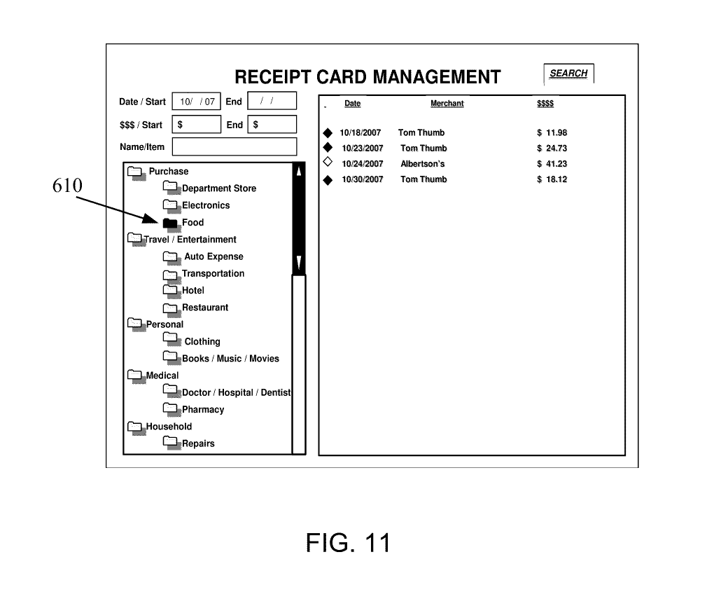

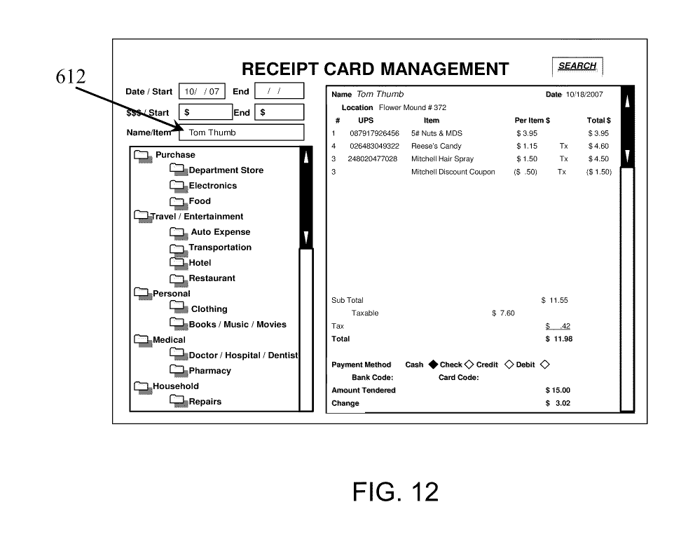

FIG. 9 illustrates a login screen from the program used to retrieve information from the external storage device. From this screen, a consumer can enter his/her user name and password or PIN number. Once the consumer has successfully logged into the program, the consumer may enter search criteria to search for information about a particular transaction. (See FIG. 10) The search criteria may include, but is not limited to, a date range, a price range or a category (personal, medical travel, etc.). FIG. 11 illustrates a screen shot showing a summary of purchases which appear when the search criteria selected is “food” under the purchase folder 610. FIG. 12 illustrates a screen shot showing a summary of purchases which appear when the search criteria selected is the name of the merchant “Tom Thumb” 612.

### Global Receipt Card Merchant Market Data

Merchants may also access and download data from the external storage device. Using a dedicated program for the consumer identifier associated with a global receipt card or other device, the merchant may download specific data/information. The dedicated program may provide security controlled access to the external data storage device and allow the merchant to display purchase record data by specific date period, items, purchase/return, price, etc. The information may be displayed without ID or global consumer detail and collective data/information may be downloaded specific to the merchant or consumer profile specific (region, time period, merchant type, etc.). As described above, the data may be downloaded to accounting software, such as QuickBooks, Quicken, etc., or a common database or spreadsheet software (Access, Excel, etc.). Programming code may be available for download to propriety software.

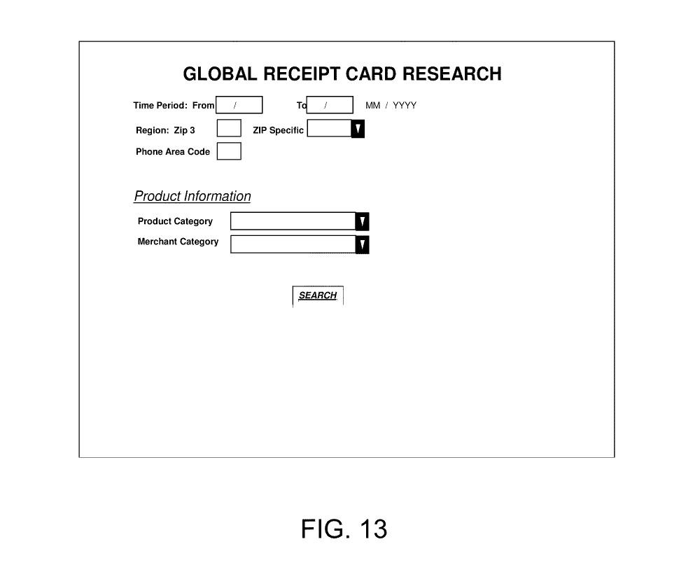

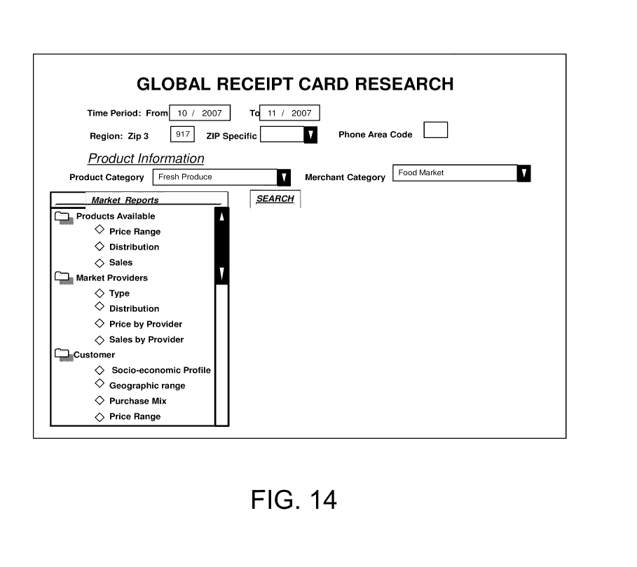

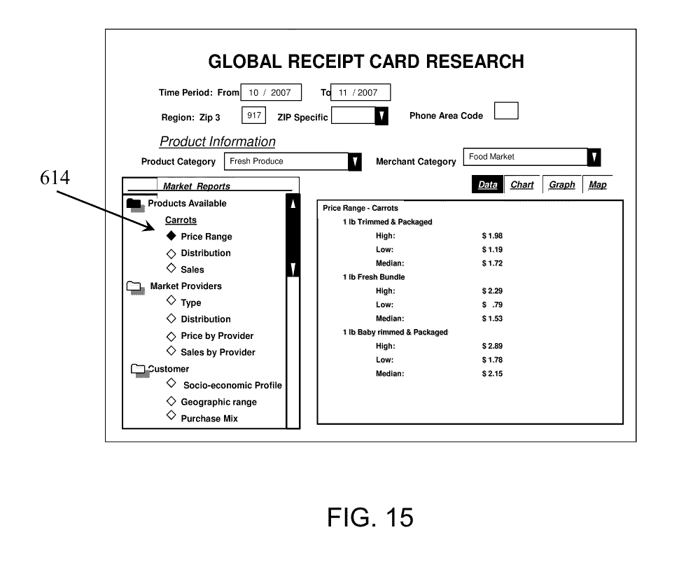

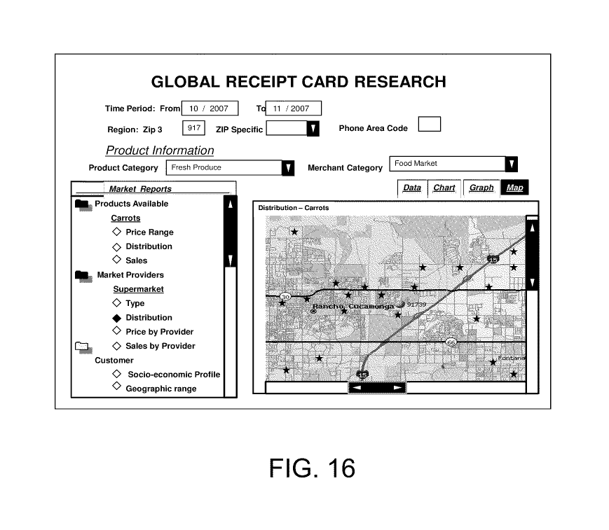

FIG. 13 illustrates a screen from the program used by merchant to enter search criteria, such as date range, region, zip code, area code, type of product and type of merchant, when searching for information. FIG. 14 illustrates a screen from the program used by the merchant to further narrow the search by selecting additional search criteria, such as available products, type of market provider and sales associated with specific traits of consumers. FIG. 14 illustrates a screen showing a summary of purchases which appear when the search criteria selected is the price of carrots. FIG. 15 illustrates a screen shot showing a summary of purchases which appear when the additional search criteria of the price range 614 of the carrots being a supermarket. FIG. 16 illustrates a screen showing search results identifying locations on a map where a consumer has transacted business with merchants.

### Global Receipt Card Data Mining—Commercial Marketing & Product Management

The data collected may be used for marketing. In one embodiment, the data may be provided in the form of summary reports and may be available to merchant subscribers through a merchant identifier. (See FIGS. 13-16) The data may provide unbiased, independent global purchase information. It may collect and aggregate information that prior art systems maintain only based on individual affinity, merchant, or payment method purchase points. The current system and method may also provide a single date resource for global purchase, sales and financial records by various key points (the date, region, ZIP code, product type, merchant type, consumer profile, payment type, consumer purchase record, etc. (See FIGS. 14-15)

Management data regarding individual consumer/merchant purchase records may also be obtained. This may provide consumer profile detail (without specifically identifying the consumers) and may include all records, regardless of payment method. Unlike prior art systems, the present system and method may provide data by broad scope merchant relationship/affinity card information to small businesses. As described above and shown in FIGS. 13-16, reports may be generated summarizing data regarding all purchases in the market based on consumer purchase profiles, competition profile comparison and a complete market summary.

A storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in the figures may be rearranged and/or combined into a single component or embodied in several components without departing from the invention. Additional elements or components may also be added without departing from the invention. Additionally, the features described herein may be implemented in software, hardware, as a business method, and/or combination thereof.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A method for collecting global purchase details, comprising:
associating a consumer identifier with a consumer, the consumer identifier for collecting transaction information on consumer purchases from a plurality of merchants;
obtaining, by a merchant device, the consumer identifier from the consumer during a business transaction between the consumer and a merchant, the merchant having a merchant identifier for collecting the transaction information;
completing the business transaction between the consumer and the merchant;
transmitting, by the merchant device, the transaction information to an external storage device; and
associating the transaction information on the external storage device with the consumer identifier and the merchant identifier.

2. The method of claim 1, further comprising retrieving, by the merchant device, consumer information from the external storage device using the consumer identifier and the merchant identifier, wherein the consumer information includes a transaction history between the consumer and the merchant.

3. The method of claim 2, wherein the transaction history is used by the consumer to return a purchased item preventing the need of a paper receipt.

4. The method of claim 1, further comprising:
providing criteria for organizing the transaction information;
compiling the transaction information based on the criteria; and
displaying the compiled transaction information.

5. The method of claim 4, wherein the criteria includes place of purchase, date of purchase, price, payment method and types of purchases.

6. The method of claim 1, wherein the transaction information is accumulated for market research.

7. The method of claim 1, wherein each of the plurality of merchants are unrelated.

8. The method of claim 1, wherein the consumer identifier is used as an address in the external storage device for storing the transaction information.

9. The method of claim 1, wherein the consumer identifier is located on an affinity card.

10. The method of claim 1, wherein the consumer identifier is a barcode and is displayed on a display screen of a mobile device.

11. A merchant device for collecting global purchase details, comprising:
a network interface for communicating over a wireless network;
a processing circuit coupled to the network interface and adapted to
obtain a consumer identifier from a consumer during a business transaction between the consumer and a merchant, the consumer identifier used for collecting consumer business transaction data from consumer purchases from a plurality of merchants;
complete the business transaction between the consumer and the merchant; and
transmit consumer business transaction data from the business transaction to an external storage device where the consumer business transaction data is associated with the consumer identifier on the external storage device.

12. The merchant device of claim 11, further comprising a card reader coupled to the network interface and the processing circuit and wherein the consumer identifier is a barcode located on an affinity card and the merchant obtains the consumer identifier with the card reader.

13. The merchant device of claim 11, wherein the merchant associates a merchant identifier with merchant business transaction data from the business transaction; and wherein the merchant identifier is used for collecting the merchant business transaction data from a plurality of consumers.

14. The merchant device of claim 11, wherein the processing circuit is further adapted to:
provide criteria for organizing the merchant business transaction data;
compile the merchant business transaction data based on the criteria; and
display the complied merchant business transaction data.

15. The merchant device of claim 14, wherein the criteria includes at least one of date range of purchases, price range of purchases, payment method purchases and types of purchases.

16. The merchant device 11, wherein the consumer identifier is used as an address in the external storage device for storing the consumer business transaction data.

17. The merchant device 13, wherein the merchant identifier is used as an address in the external storage device for storing the merchant business transaction data.

18. A merchant device for collecting global purchase details, comprising:
means for obtaining a consumer identifier from a consumer during a business transaction between the consumer and a merchant, the consumer identifier used for collecting consumer business transaction data from consumer purchases from a plurality of merchants;
means for completing the business transaction between the consumer and the merchant; and
means for transmitting consumer business transaction data from the business transaction to an external storage device where the consumer business transaction data is associated with the consumer identifier on the external storage device.

19. The merchant device of claim 18, wherein the consumer identifier is a barcode located on an affinity card and the merchant obtains the consumer identifier with the card reader.

20. The merchant device of claim 18, wherein the merchant associates a merchant identifier with merchant business transaction data from the business transaction; and wherein the merchant identifier is used for collecting the merchant business transaction data from a plurality of consumers.
